(19) United States
(12) Patent Application Publication
(10) Pub. No.: US 2025/0307322 A1
(43) Pub. Date: Oct. 2, 2025

(54) DOMAIN ADAPTING A LLM IN THE ENERGY INDUSTRY

(71) Applicant: Schlumberger Technology Corporation, Sugar Land, TX (US)

(72) Inventors: Neelansh Garg, Sunnyvale, CA (US); Daria Sergeyevna Khvostichenko, Houston, TX (US); Monisha Manoharan, Menlo Park, CA (US)

(21) Appl. No.: 19/093,774

(22) Filed: Mar. 28, 2025

Related U.S. Application Data
(60) Provisional application No. 63/571,155, filed on Mar. 28, 2024.

(51) Int. Cl. G06F 16/93; G06F 16/22; G06F 16/242; G06F 16/248; G06F 16/25

(52) U.S. Cl. CPC G06F 16/93; G06F 16/2237; G06F 16/243; G06F 16/248; G06F 16/258

(57) ABSTRACT

A method for using generative artificial intelligence to generate an answer in response to a natural language query that is directed to oil and gas exploration, drilling, and/or production includes receiving a plurality of documents. The method also includes splitting the documents into chunks. The method also includes generating a plurality of embeddings based upon the chunks. The method also includes storing the chunks and the embeddings in a vector database. The method also includes receiving a natural language query directed to oil and gas exploration, drilling, and/or production. The method also includes generating a query embedding based upon the natural language query. The method also includes retrieving a subset of the chunks based upon the query embedding. The method also includes generating an answer in response to the natural language query. The answer is based upon the natural language query and the subset of the chunks.

### CROSS-REFERENCE TO RELATED APPLICATIONS

This application claims priority to U.S. Provisional Patent Application No. 63/571,155, filed on Mar. 28, 2024, which is incorporated by reference in its entirety.

### BACKGROUND

Text-based generative artificial intelligence (GenAI) facilitated by large language models (LLMs) has stormed its way into everyday life, providing efficiencies in consuming and producing information used in daily tasks. Specifically, humans can interact with LLMs through natural language questions and answers (Q&A) to query information available to the LLMs. There are many potential applications of LLMs in specific fields (e.g., the energy industry), such as Searchable Knowledge Bases, Smart Tickets, IT services etc.

However, LLMs are hindered by their general-purpose nature. More particularly, they have been trained on vast amounts of publicly available text data. As a result, they may not be trained to deal with specific technical domains with the level of knowledge and accuracy used by technical personnel.

Therefore, what is needed is an improved system and method for answering natural language questions, related to specific technical domains, with information that is not publicly available.

### SUMMARY

A method for using generative artificial intelligence to generate an answer in response to a natural language query that is directed to oil and gas exploration, drilling, and/or production is disclosed. The method includes receiving a plurality of documents. The method also includes splitting the documents into chunks. The method also includes generating a plurality of embeddings based upon the chunks. The method also includes storing the chunks and the embeddings in a vector database. The method also includes receiving a natural language query directed to oil and gas exploration, drilling, and/or production. The method also includes generating a query embedding based upon the natural language query. The method also includes retrieving a subset of the chunks based upon the query embedding. The method also includes generating an answer in response to the natural language query. The answer is based upon the natural language query and the subset of the chunks.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving a plurality of documents. The documents include unstructured data. The unstructured data includes text directed to oil and gas exploration, drilling, or production. The operations also include converting the documents from a first document format into a second document format. Converting the documents includes performing optical character recognition (OCR) on the unstructured data in a portable document format (PDF) to convert the unstructured data into a text format. The operations also include splitting the documents in the second document format into chunks. The operations also include generating a plurality of embeddings based upon the chunks. Each embedding corresponds to a different one of the chunks. The embeddings are generated using a deep learning model. The embeddings include multi-dimensional vectors in a form of real numbers. The operations also include storing the chunks, the embeddings, and associated metadata in a vector database. The operations also include receiving a natural language query directed to oil and gas exploration, drilling, or production. The operations also include generating a query embedding based upon the natural language query. The query embedding is generated using the deep learning model. The operations also include retrieving a subset of the chunks based upon the query embedding. The subset of the chunks is retrieved using an approximate nearest neighbor algorithm. The operations also include generating an answer in response to the natural language query. The answer is based upon the natural language query and the subset of the chunks.

A non-transitory computer-readable medium is also disclosed. The medium stores instructions that, when executed by one or more processors of a computing system, cause the computing system to perform operations. The operations include receiving a plurality of documents. The documents include unstructured data. The unstructured data includes text directed to oil and gas exploration, drilling, or production. The operations also include converting the documents from a first document format into a second document format. Converting the documents includes performing optical character recognition (OCR) on the unstructured data in a portable document format (PDF) to convert the unstructured data into a text format. The operations also include splitting the unstructured data in the second document format into chunks. The operations also include generating a plurality of embeddings based upon the chunks. Each embedding corresponds to a different one of the chunks. The embeddings are generated using a deep learning model. The embeddings include multi-dimensional vectors in a form of real numbers. The operations also include storing the chunks, the embeddings, and associated metadata in a vector database. The operations also include receiving a natural language query directed to oil and gas exploration, drilling, or production. The operations also include generating a query embedding based upon the natural language query. The query embedding is generated using the deep learning model. The operations also include retrieving a subset of the chunks based upon the query embedding. The subset of the chunks is retrieved using an approximate nearest neighbor algorithm. The operations also include generating an answer in response to the natural language query. The answer is based upon the natural language query, the subset of the chunks, and a system prompt. The answer includes the subset of the chunks and a summary of the subset of the chunks. The summary is non-verbatim of the subset of the chunks. The answer is generated by a large language model (LLM). The LLM has access to domain-specific documents that include text directed to oil and gas exploration, drilling, or production. The LLM is not trained using the domain-specific documents. The system prompt includes instructions for how to answer the natural language query.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for using GenAI to generate an answer in response to a natural language query, according to an embodiment.

FIG. 3 illustrates a schematic view of the flowchart in FIG. 2, according to an embodiment.

FIG. 4 illustrates a chatbot user interface (UI), according to an embodiment.

FIG. 5 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

The present disclosure includes a domain-adapted LLM that can be used by technical personnel in the energy (e.g., oil and gas) industry. The present disclosure provides conversational Q&A capability about oil and gas (O&G) products and services. The method described herein achieves this by implementing a Retrieval Augmented Generation (RAG) pipeline on domain-specific data, which in this specific case is the energy domain. RAG is a mature approach in the world of natural language processing (NLP), but it has come to light again due to the recent advancement in the industry due to the introduction of large pre-trained models such as Chat GPT. RAG reduces hallucinations and helps the language model generate better answers which can also be verified. It includes two parts: (1) a retriever that retrieves the relevant documents given a query, and (2) a question-answering model that generates the answer given the query and the retrieved documents. The method described herein has adopted the concept of RAG to implement a chatbot for O&G products and services. The approach has been modified for the given data.

### System Overview

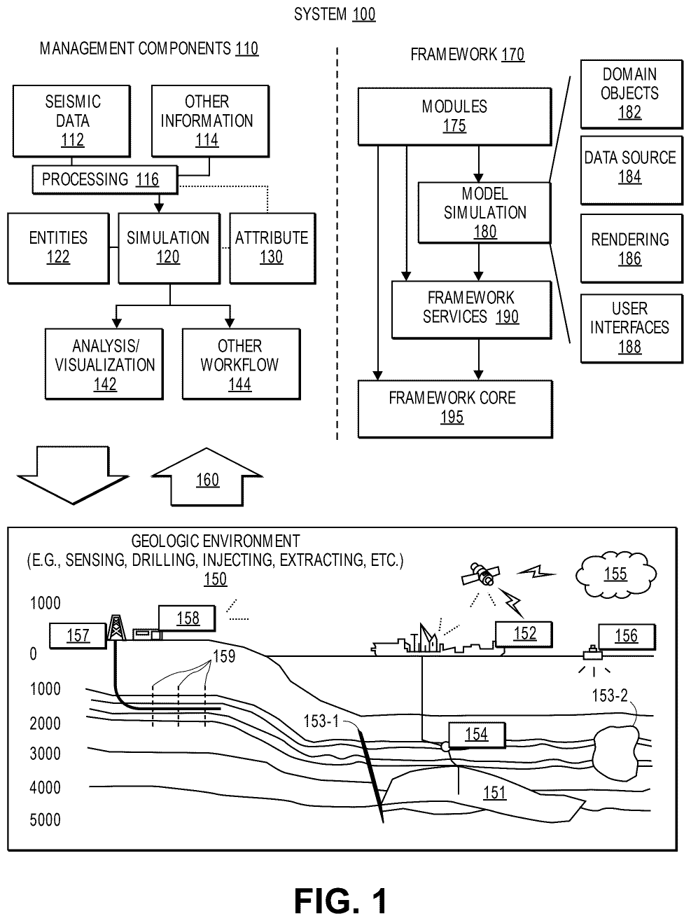

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY software (SLB, Houston, Texas). More particularly, SYMMETRY may process workflows in a single integrated environment with accurate thermodynamic fluid representation and consistent modeling across multiple disciplines including process, production, and HSE. The simulator integrates steady-state and transient (e.g., dynamic) analyses that can be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM (SLB, Houston, Texas). More particularly, PIPESIM is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Exemplary Method

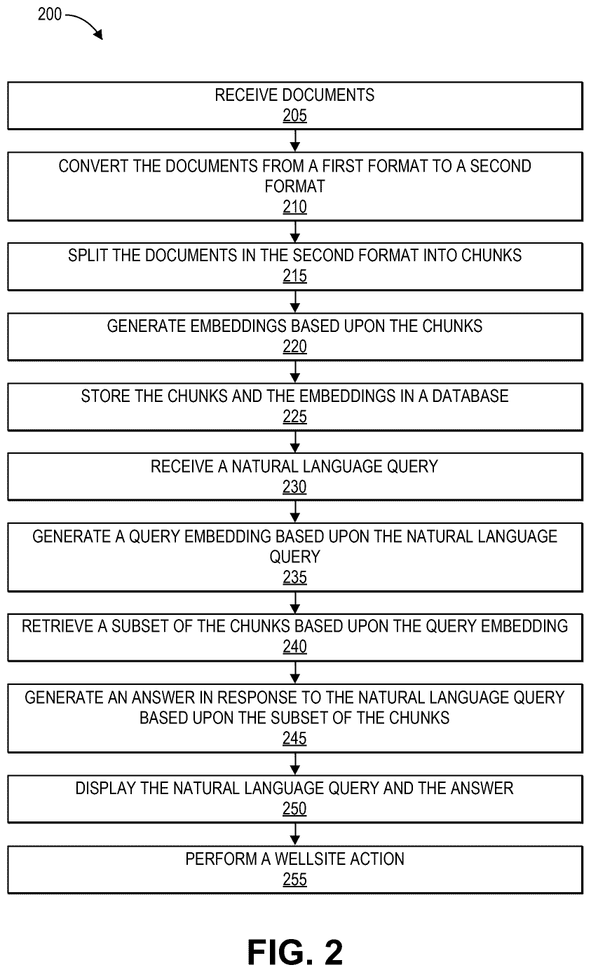

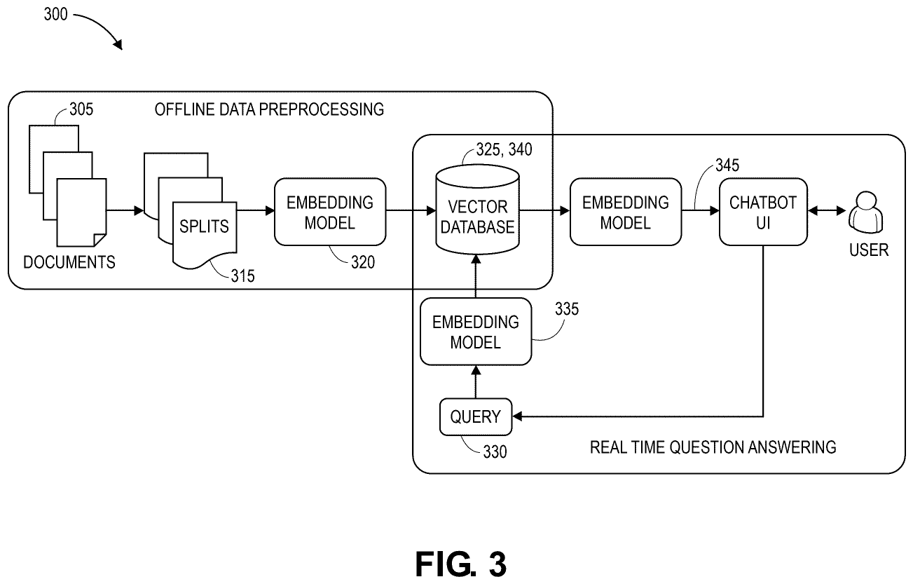

FIG. 2 illustrates a flowchart of a method 200 for using GenAI to generate an answer in response to a natural language query, according to an embodiment. FIG. 3 illustrates a schematic view of the flowchart in FIG. 2, according to an embodiment. An illustrative order of the method 200 is provided below; however, one or more portions of the method 200 may be performed in a different order, simultaneously, repeated, or omitted. At least a portion of the method 200 may be performed by a computing system 500 (described below).

### Offline Data Processing

The method 200 may include receiving a plurality of documents, as at 205 (and 305 in FIG. 3). The documents may include unstructured data. The unstructured data may include text directed to the energy industry (e.g., oil and gas exploration, drilling, and/or production).

The method 200 may also include converting the documents from a first document format into a second document format, as at 210. Step(s) 205 and/or 210 may be referred to as document loading. The received documents may be processed and converted into the appropriate format. For example, portable document format (PDF) documents may be loaded and converted to text using techniques like optical character recognition (OCR). The converted documents may then be indexed.

The method 200 may also include splitting the documents into chunks, as at 215 (and 315 in FIG. 3). More particularly, the documents may be split into smaller chunks appropriate for the input length of the embedding model (described below). For example, a document may be split into paragraphs.

The method 200 may also include generating a plurality of embeddings based upon the chunks, as at 220 (and 320 in FIG. 3). Each embedding may correspond to a different one of the chunks. The embeddings may be generated using a deep-learning model. The embeddings may include multi-dimensional vectors that represent the document or a chunk (e.g., a piece of the document) in the form of real numbers (e.g., Euclidean space).

The method 200 may also include storing the chunks and/or the embeddings in a database, as at 225 (and 325 in FIG. 3). This may also include storing metadata associated with the chunks and/or the embeddings in the database. The database may be or include a vector database.

### Online Real-Time Q&A

After the index is created, it may be used to answer incoming user queries. This may be done in real-time and have stricter latency rules than the offline data processing.

The method 200 may also include receiving a natural language query, as at 230 (and 330 in FIG. 3). The query may be directed to the energy industry (e.g., oil and gas exploration, drilling, and/or production).

The method 200 may also include generating a query embedding based upon the natural language query, as at 235 (and 335 in FIG. 3). The query embedding may be generated using the (e.g., same) deep learning model described above.

The method 200 may also include retrieving a subset of the chunks based upon the query embedding, as at 240 (and 340 in FIG. 3). The subset of the chunks may be retrieved based upon the query embedding, which was generated in a similar fashion as the chunk embeddings (e.g., using the same model that was used to generate the embedding). The subset of the chunks may be retrieved from the (e.g., vector) database. The subset of the chunks may be retrieved using an approximate nearest neighbor algorithm.

The method 200 may also include generating an answer in response to the natural language query, as at 245 (and 345 in FIG. 3). The answer may be based upon the subset of the chunks that are retrieved. The answer includes the subset of the chunks and/or a (e.g., non-verbatim) summary of the subset of the chunks. The answer may be generated by a large language model (LLM). The large language model may have access to domain-specific documents that include text directed to oil and gas exploration, drilling, and/or production. In one embodiment, the large language model may not be trained using the domain-specific documents. The answer may also be generated in response to a system prompt. The system prompt may include instructions for how to answer the natural language query. The system prompt may be optimized to provide accurate answers on a dedicated subject matter assessment. The system prompt may be optimized by making iterative improvements and programmatic improvements.

Said another way, the LLM may be asked to generate the answer in response to the natural language query and the retrieved subset of the chunks. This answer is then returned to the user using an application programming interface (API) or user interface (UI). One characteristic of this deployment of the model is that the output is streamed to the user token-by-token as it is generated. A token represents a word or a word piece in natural language processing (NLP). This helps to maintain the real time characteristics of the application.

The method 200 may also include displaying the natural language query and the answer, as at 250.

The method 200 may also include performing a wellsite action, as at 255. The wellsite action may be based upon or in response to the answer. The wellsite action may be or include generating and/or transmitting a signal (e.g., using a computing system) that recommends, instructs, or causes a physical action to occur at a wellsite. The wellsite action may also or instead include performing the physical action at the wellsite. In an example, the physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

### Chatbot User Interface

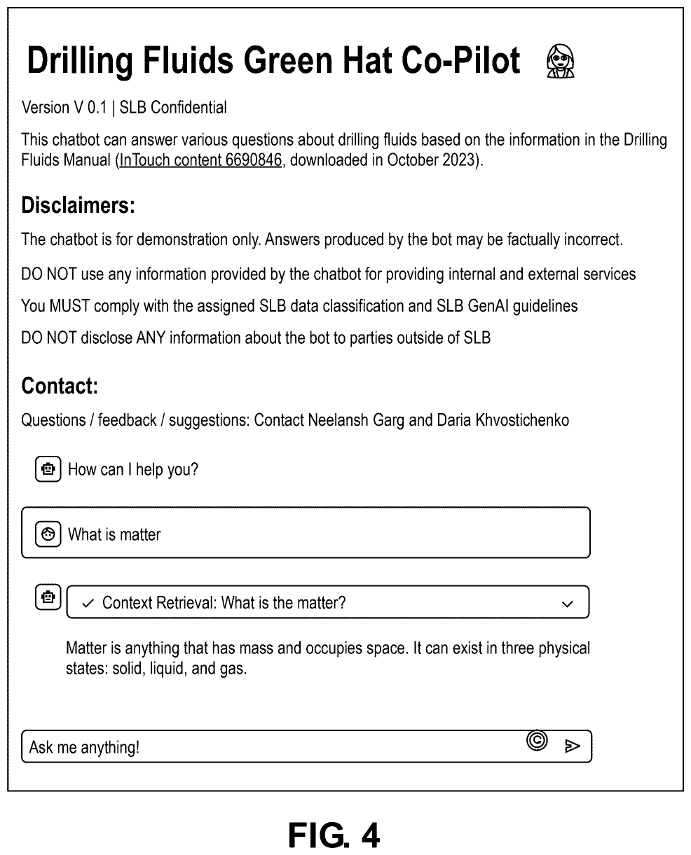

FIG. 4 illustrates a chatbot user interface (UI) for the method 200, according to an embodiment. This is a chatbot interface in which the user can ask a query regarding the given documents, and the model returns the answer. The chatbot UI may also display the retrieved context to the user so that the user can verify the source of information and ensure that the model has generated the right answer. The UI may display the generated output token-by-token to maintain the real-time capabilities of the model.

The method 200 may prove useful for persons or organizations that have a vast amount of data, both structured and unstructured, that is used in various ways by many functions. Recently developed LLMs have demonstrated great capabilities for a variety of generative tasks but they do not possess the requisite level of knowledge of highly technical domains such as oil and gas and have no information about energy-specific policies, procedures, technologies, and products. The domain-informed LLM chatbot described herein transforms information search and retrieval when interacting with internal and external energy-related products and greatly increases efficiency of personnel.

As described above, the chatbot uses LLMs and retrieval-augmented generation (RAG) to tap into unstructured documentation for technical support, incident investigation, and case studies and aids the technology, product and service delivery, sales and commercial, and learning and development teams during their daily activities. Specific examples of tasks can include answering general questions about a specific domain such as drilling fluids, information about O&G products and offerings, and a summary of O&G experience with specific technologies, and drilling environments. Initially, the chatbot may focus on well-construction fluids data to develop a framework for domain-specific bots, which can then be extended to other sub-business lines and divisions.

A POC of a drilling fluids chatbot has been built. Compared to the identical question asked in general-purpose ChatGPT-3.5 on Dec. 15, 2023, the domain-adapted chatbot described herein provides much more concise and specific information. Example results of the general-purpose ChatGPT-3.5 versus the domain-adapted Fluid_Engineer_GPT in response to a drilling fluid Q&A are shown in Table 1 below. Furthermore, the domain-adapted Fluid_Engineer_GPT readily provides information about specific company (i.e., commercial) products that should be used in each scenario. The answer given by the general-purpose ChatGPT is not useful for technical personnel using/delivering products and services related to a O&G or a particular company in that industry. While some of the deficiencies of general-purpose models can be addressed with prompt engineering to make answers more relevant for technical domains, field personnel may not have the time or expertise for that.

TABLE 1
Question: Please list corrosion inhibitors used in drilling fluids.

| | |
|---|---|
| Answer by OpenAI GPT-3.5, retrieved Dec. 15, 2023 | Answer by |
| | Fluid_Engineer_GPT, |
| | retrieved Dec. 15, 2023 |
| Corrosion inhibitors are added to drilling fluids to protect metal | Some examples of |
| components and equipment from corrosion. The selection of a | corrosion inhibitors |
| corrosion inhibitor depends on factors such as the type of metal being | used in drilling fluids |
| protected, the drilling fluid composition, and the environmental | are CONQOR 101, |
| conditions. Here are some common corrosion inhibitors used in drilling | CONQOR 303 A, |
| fluids: | CONQOR 404, and |
| | SI-1000. |
| 1. **Amines:** | |
| Ethanolamine (ETA), diethanolamine (DEA), and triethanolamine | |
| (TEA) are examples of amines used as corrosion inhibitors. They form | |
| protective films on metal surfaces. | |
| 2. **Quaternary Ammonium Compounds (QACs):** | |
| Compounds such as benzalkonium chloride and alkyl dimethyl | |
| benzyl ammonium chloride can function as corrosion inhibitors in | |
| addition to their biocidal properties. | |
| 3. **Phosphonates:** | |
| Compounds like amino trimethylene phosphonic acid (ATMP) and | |
| ethylene diamine tetra(methylene phosphonic acid) (EDTMP) are | |
| effective corrosion inhibitors. | |
| 4. **Organic Acids:** | |
| Organic acids such as acetic acid and formic acid can act as | |
| corrosion inhibitors. They form a protective layer on metal surfaces. | |
| 5. **Chelating Agents:** | |
| Chelating agents like ethylenediaminetetraacetic acid (EDTA) can | |
| help prevent corrosion by forming stable complexes with metal ions. | |
| 6. **Molybdates:** | |
| Sodium molybdate and other molybdenum-based compounds are | |
| commonly used as corrosion inhibitors in drilling fluids. | |
| 7. **Borate Compounds:** | |
| Borate salts, such as sodium borate, can act as corrosion inhibitors | |
| and also contribute to the alkalinity of the drilling fluid. | |
| 8. **Zinc Compounds:** | |
| Zinc-based inhibitors, such as zinc oxide or zinc bromide, are used | |
| to protect ferrous metals from corrosion. | |
| 9. **Nitrogen Compounds:** | |
| Compounds containing nitrogen, such as amides and amines, can | |
| function as corrosion inhibitors. | |
| 10. **Surfactants:** | |
| Certain surfactants have corrosion-inhibiting properties and can be | |
| included in drilling fluid formulations for this purpose. | |
| 11. **Aldehydes:** | |
| Aldehydes like glutaraldehyde, in addition to their role as biocides, | |
| can provide corrosion protection. | |
| 12. **Lignosulfonates:** | |
| Lignosulfonates, derived from wood pulping processes, can act as | |
| corrosion inhibitors in certain drilling fluid formulations. | |
| The effectiveness of corrosion inhibitors can vary depending on the | |
| specific conditions of the drilling operation. Mud engineers or drilling | |
| fluid specialists typically determine the appropriate corrosion inhibitor | |
| based on the equipment in use, well conditions, and the desired level of | |
| protection. Regular monitoring of corrosion rates and adjusting | |
| inhibitor concentrations as needed are essential for maintaining the | |
| integrity of drilling equipment. | |

Presently, the POC is capable of answering questions about multiple unstructured documents using an existing LLM and retrieval-augmented generation. This technology can be easily extended to other O&G-relevant domains. Further development of the technology can include LLM fine-tuning, development of the assessment framework for comparing various GenAI retrieval technologies, and the addition of interactive capabilities for other modalities of data such as tables, text, images, and engineering drawings. Chatbot assistants or co-pilots can be included in internal business systems, internal software products used in O&G product and service delivery, and client-facing software products.

Currently, information search and retrieval is done manually from existing documents and/or by consulting with domain experts. The technology described herein transforms the way users perform knowledge-based tasks in our daily jobs in the oil and gas industry by generating answers with a model that has been trained using data related to specific technological domains. An accuracy assessment has been performed to compare the outputs from the method 200 to outputs from conventional methods (e.g., “as-is” GPT-3.5). More specifically, the performance of the method 200 with document retrieval has been tested on a dedicated subject matter assessment. The results showed an accuracy improvement from 69% for the “as-is” GPT-3.5 to 75% for the document-augmented pipeline (e.g., method 200). The testing involved a set of 400 multiple choice questions used for competency assessment of field engineers.

In one embodiment, the model in the method 200 may not be trained or fine-tuned specifically on domain documents. It may, however, use domain documents in a different way. The method 200 may retrieve knowledge specific to the prompt from domain documents and use this to produce the answer (i.e., retrieval-augmented generation, or RAG). The 400 assessment questions were tested with (1) the conventional model—i.e., without using RAG or domain-specific documents, and (2) the method 200 including RAG on domain-specific documents. An accuracy improvement may be seen in approach #2 (75%) compared to approach #1 (69%). In the testing, the domain documents include training material for field engineering schools, and the assessment questions were the questions given to the field engineers in that school.

Another way to explain the method 200 is that a LLM model can be thought of as a “brain” that has already learned a lot of information about the world. In Approach #1 (conventional “as-is” model, no augmentation), the brain simply relies on the information it has already learned about the world. It may or may not be enough to answer specific domain question. In Approach #2 (method 200 including augmentation), the brain still has the same intrinsic knowledge as before, but it is also given documents that contain additional domain-specific knowledge. Using its intrinsic language processing capabilities, the brain is able to find relevant segments in these documents in response to prompts and to perform requested task (e.g., Q&A). The brain does not retain the information about the contents of these documents, and the process may be repeated access to them to maintain response accuracy. Another approach (e.g., Approach #3) may be fine-tuning, where the brain actually “learns” and retains the information from domain-specific documents. That way, the brain may be able to perform prompted tasks accurately even when it does not have access to the document base.

### Exemplary Computing System

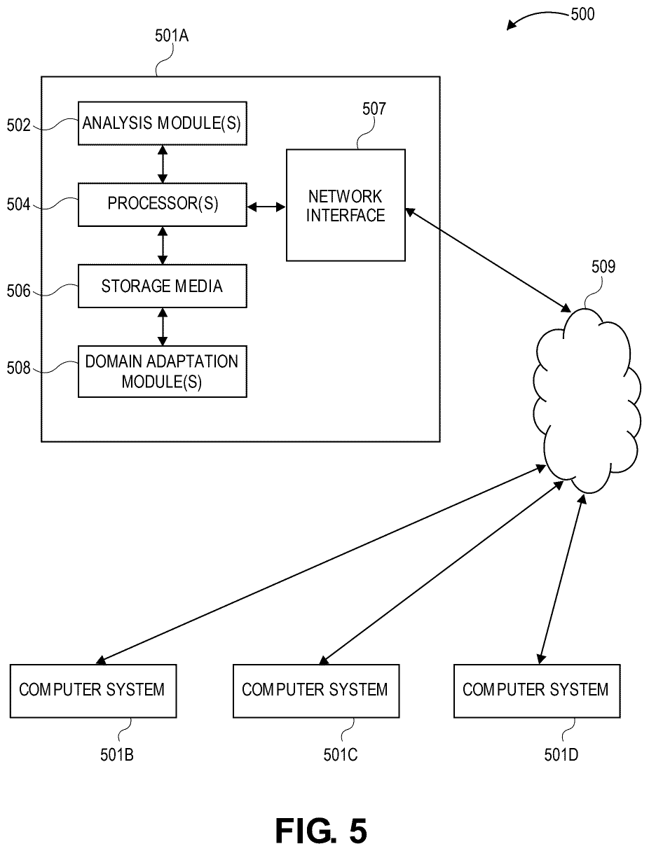

In some embodiments, the methods of the present disclosure may be executed by a computing system. FIG. 5 illustrates an example of such a computing system 500, in accordance with some embodiments. The computing system 500 may include a computer or computer system 501A, which may be an individual computer system 501A or an arrangement of distributed computer systems. The computer system 501A includes one or more analysis modules 502 that are configured to perform various tasks according to some embodiments, such as one or more methods disclosed herein. To perform these various tasks, the analysis module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506 may be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 500 contains one or more domain adaptation module(s) 508. In the example of computing system 500, computer system 501A includes the domain adaptation module 508. In some embodiments, a single domain adaptation module may be used to perform some aspects of one or more embodiments of the methods disclosed herein. In other embodiments, a plurality of domain adaptation modules may be used to perform some aspects of methods herein.

It should be appreciated that computing system 500 is merely one example of a computing system, and that computing system 500 may have more or fewer components than shown, may combine additional components not depicted in the example embodiment of FIG. 5, and/or computing system 500 may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for using generative artificial intelligence to generate an answer in response to a natural language query that is directed to oil and gas exploration, drilling, and/or production, the method comprising:
receiving a plurality of documents;
splitting the documents into chunks;
generating a plurality of embeddings based upon the chunks;
storing the chunks and the embeddings in a vector database;
receiving a natural language query directed to oil and gas exploration, drilling, and/or production;
generating a query embedding based upon the natural language query;
retrieving a subset of the chunks based upon the query embedding; and
generating an answer in response to the natural language query, wherein the answer is based upon the natural language query and the subset of the chunks.

2. The method of claim 1, wherein the documents comprise unstructured data, and wherein the unstructured data comprises text directed to oil and gas exploration, drilling, and/or production.

3. The method of claim 2, further comprising converting the documents from a first document format into a second document format, wherein the documents in the second document format are split into the chunks.

4. The method of claim 3, wherein converting the documents comprises performing optical character recognition (OCR) on the unstructured data in a portable document format (PDF) to convert the unstructured data into a text format.

5. The method of claim 1, wherein each embedding corresponds to a different one of the chunks, wherein the embeddings are generated using a deep learning model, and wherein the embeddings comprise multi-dimensional vectors in a form of real numbers.

6. The method of claim 5, wherein the query embedding is generated using the deep learning model.

7. The method of claim 1, wherein the subset of the chunks is retrieved using an approximate nearest neighbor algorithm.

8. The method of claim 1, further comprising displaying the natural language query and the answer.

9. The method of claim 1, further comprising performing a wellsite action in response to the answer.

10. The method of claim 9, wherein the wellsite action comprises selecting where to drill a wellbore, drilling the wellbore, varying a weight and/or torque on a drill bit that is drilling the wellbore, varying a drilling trajectory of the wellbore, varying physical and/or chemical properties of a fluid pumped into the wellbore, or varying a flow rate of the fluid pumped into the wellbore.

11. A computing system, comprising:
one or more processors; and
a memory system comprising one or more non-transitory computer-readable media storing instructions that, when executed by at least one of the one or more processors, cause the computing system to perform operations, the operations comprising:
receiving a plurality of documents, wherein the documents comprise unstructured data, wherein the unstructured data comprises text directed to oil and gas exploration, drilling, or production;
converting the documents from a first document format into a second document format, wherein converting the documents comprises performing optical character recognition (OCR) on the unstructured data in a portable document format (PDF) to convert the unstructured data into a text format;
splitting the documents in the second document format into chunks;
generating a plurality of embeddings based upon the chunks, wherein each embedding corresponds to a different one of the chunks, wherein the embeddings are generated using a deep learning model, and wherein the embeddings comprise multi-dimensional vectors in a form of real numbers;
storing the chunks, the embeddings, and associated metadata in a vector database;
receiving a natural language query directed to oil and gas exploration, drilling, or production;
generating a query embedding based upon the natural language query, wherein the query embedding is generated using the deep learning model;
retrieving a subset of the chunks based upon the query embedding, wherein the subset of the chunks is retrieved using an approximate nearest neighbor algorithm; and
generating an answer in response to the natural language query, wherein the answer is based upon the natural language query and the subset of the chunks.

12. The computing system of claim 11, wherein the answer comprises the subset of the chunks and a summary of the subset of the chunks, and wherein the summary is non-verbatim of the subset of the chunks.

13. The computing system of claim 11, wherein the answer is generated by a large language model (LLM), wherein the LLM has access to domain-specific documents that comprise text directed to oil and gas exploration, drilling, or production, and wherein the LLM is not trained using the domain-specific documents.

14. The computing system of claim 11, wherein the answer is also based upon a system prompt, and wherein the system prompt comprises instructions for how to answer the natural language query.

15. The computing system of claim 11, wherein the operations further comprise displaying the natural language query and the answer using a graphical user interface (GUI).

16. A non-transitory computer-readable medium storing instructions that, when executed by one or more processors of a computing system, cause the computing system to perform operations, the operations comprising:
receiving a plurality of documents, wherein the documents comprise unstructured data, wherein the unstructured data comprises text directed to oil and gas exploration, drilling, or production;
converting the documents from a first document format into a second document format, wherein converting the documents comprises performing optical character recognition (OCR) on the unstructured data in a portable document format (PDF) to convert the unstructured data into a text format;
splitting the unstructured data in the second document format into chunks;
generating a plurality of embeddings based upon the chunks, wherein each embedding corresponds to a different one of the chunks, wherein the embeddings are generated using a deep learning model, and wherein the embeddings comprise multi-dimensional vectors in a form of real numbers;
storing the chunks, the embeddings, and associated metadata in a vector database;
receiving a natural language query directed to oil and gas exploration, drilling, or production;
generating a query embedding based upon the natural language query, wherein the query embedding is generated using the deep learning model;
retrieving a subset of the chunks based upon the query embedding, wherein the subset of the chunks is retrieved using an approximate nearest neighbor algorithm; and
generating an answer in response to the natural language query, wherein the answer is based upon the natural language query, the subset of the chunks, and a system prompt, wherein the answer comprises the subset of the chunks and a summary of the subset of the chunks, wherein the summary is non-verbatim of the subset of the chunks, wherein the answer is generated by a large language model (LLM), wherein the LLM has access to domain-specific documents that comprise text directed to oil and gas exploration, drilling, or production, wherein the LLM is not trained using the domain-specific documents, and wherein the system prompt comprises instructions for how to answer the natural language query.

17. The non-transitory computer-readable medium of claim 16, wherein the system prompt is optimized to provide accurate answers on a dedicated subject matter assessment.

18. The non-transitory computer-readable medium of claim 16, wherein the system prompt is optimized by making iterative improvements and programmatic improvements.

19. The non-transitory computer-readable medium of claim 16, wherein the answer is 50 words or less and contains names of commercial products relevant for a specific scenario identified in the natural language query.

20. The non-transitory computer-readable medium of claim 16, wherein the operations further comprise performing a wellsite action in response to the answer, wherein the wellsite action comprises generating and transmitting a signal that recommends, instructs, or causes a physical action to occur.
